(19) United States
(12) Patent Application Publication
(10) Pub. No.: US 2008/0005067 A1
(43) Pub. Date: Jan. 3, 2008

(54) CONTEXT-BASED SEARCH, RETRIEVAL, AND AWARENESS

(75) Inventors: Susan T. Dumais, Kirkland, WA (US); Kyle G. Peltonen, Issaquah, WA (US); Anoop Gupta, Woodinville, WA (US); Bradly A. Brunell, Medina, WA (US); William H. Gates, Medina, WA (US); Gary W. Flake, Bellevue, WA (US); Ramez Naam, Seattle, WA (US); Eric J. Horvitz, Kirkland, WA (US); Xuedong D. Huang, Bellevue, WA (US); John C. Platt, Redmond, WA (US); Oliver Hurst-Hiller, New York, NY (US); Trenholme J. Griffin, Bainbridge Island, WA (US); Joshua T. Goodman, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/426,981

(22) Filed: Jun. 28, 2006

(51) Int. Cl. G06F 17/30

(52) U.S. Cl. 707/3

(57) ABSTRACT

A system that incorporates a user context into a computer-based search is provided. To establish the context, the innovation can identify information about a user state or context via a variety of sources and sensors. The state/context information can be used to filter, arrange and/or rank search results so as to facilitate converging on meaningful searches and results. Machine learning systems (implicitly and/or explicitly trained) can be employed to infer a current and/or future context related to user. An identified or inferred user context can be employed to modify an automated or user-defined search input/query. Contextual cues can be considered directly in the construction and use of context of context-sensitive retrieval algorithms that are optimized for identifying and/or ranking of informational items of potential interest or value in different contexts. As well, the context can be employed to intelligently render results of a query (e.g., user/application defined, context-modified query).

### CROSS-REFERENCE TO RELATED APPLICATIONS

This application is related to pending U.S. patent application Ser. No. 11/294,269 entitled “IMPROVING RANKING RESULTS USING MULTIPLE NESTED RANKING SYSTEM” filed on Dec. 5, 2005 and to pending U.S. patent application Ser. No. ______ entitled “CONTEXT-BASED SEARCH, RETRIEVAL, AND AWARENESS”, Attorney Docket Reference MSFTP1413US filed on Jun. 28, 2006. The entireties of the above-noted applications are incorporated by reference herein.

### BACKGROUND

The Internet and the World Wide Web continue to evolve rapidly with respect to both volume of information and number of users. The Internet is a collection of interconnected computer networks. The World Wide Web, or simply the web, is a service that connects numerous Internet accessible sites via hyperlinks and uniform resource locators (URLs). As a whole, the web provides a global space for accumulation, exchange and dissemination of information. Further, the number of users continues to increase as more and more pertinent information becomes accessible over the web.

To maximize likelihood of locating relevant information amongst an abundance of data, Internet or web search engines are regularly employed. In some instances, a user knows the name of a site, server or URL to the site or server that is desired for access. In such situations, the user can access the site, by simply entering the URL in an address bar of a browser and connect to the site.

However, in most instances, the user does not know the URL or the name of the site that includes desired information. To find the site or the corresponding URL of interest, the user can employ a search engine to facilitate locating and accessing sites based on keywords and Boolean operators. A search engine is a tool that facilitates web navigation based upon entry of a search query comprising one or more keywords. Upon receipt of a search query, the search engine retrieves a list of websites, typically ranked based on relevance to the query. To enable this functionality, the search engine must generate and maintain a supporting infrastructure.

First, search engines agents, often referred to as spiders or crawlers, navigate websites in a methodical manner and retrieve information about sites visited. For example, a crawler can make a copy of all or a portion of websites and related information. The search engine then analyzes the content captured by one or more crawlers to determine how a page will be indexed. Some engines will index all words on a website while others may only index terms associated with particular tags such as such as title, header or metatag(s). In addition, engines can index terms associated with pages obtained from sources such as anchor text, tags, advertising keywords or previous queries. Crawlers must also periodically revisit webpages to detect and capture changes thereto since the last indexing.

Once the indexes are generated, they are assigned a ranking with respect to certain keywords and stored in a database. A proprietary algorithm is often employed to evaluate the index for relevancy, for example, based on frequency and location of words on a webpage, among other things. Accordingly, a main difference between conventional search engines and performance thereof is the ranking algorithm that is employed.

Upon entry of one or more keywords as a search query, the search engine retrieves indexed information that matches the query from the database, generates a snippet of text associated with each of the matching sites and displays the results to a user. The user can thereafter scroll through a plurality of returned sites to attempt to determine if the sites are related to the interests of the user. However, this can be an extremely time-consuming and frustrating process as search engines can return a substantial number of sites. More often then not, the user is forced to narrow the search iteratively by altering and/or adding keywords and Boolean operators to obtain the identity of websites including relevant information.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that can incorporate a user and/or device context into a computer-based search, (e.g., Internet search, news search, advertisement search, . . . ). For example, in one aspect of the novel subject matter, the context can be employed to modify a user-defined search input/query. In another aspect, the context can be employed to render results of a query (e.g., user/application defined, context-modified query).

The innovation can provide for incorporating user state/context into a user-defined input search or query. For example, information about user state can be obtained from a variety of sources such as, for example, location detection mechanisms (e.g., global position system (GPS), motion detectors), application contextual information (e.g., applications the user is working with), temporal detectors (e.g., time of day/date, special periods of time such as holidays, forthcoming holidays, etc.), personal information manager (PIM) data (e.g., user's calendar), visual monitors (e.g., to detect user mood, location of landmarks), audio detectors (e.g., microphone in conjunction with voice recognition to identify stress in user's voice, sense of urgency, background noises), particular location/activity of a user (e.g., at the office, within a car, walking), etc.

In addition to modifying a user-defined input search or query, this state/context information can be used to filter, arrange and/or rank search results so as to facilitate converging on meaningful searches and results. For example, once results are returned as a result of a user input and/or a context-modified user input, the results can be rendered by taking into account detected, determined and/or inferred user context-metadata about location and items can be employed to facilitate such searching.

Machine learning systems (implicitly as well as explicitly trained) can be employed so as to provide automated action in connection with the innovation. For example, machine learning systems can be employed to infer a current and/or future user context related to user. In this aspect, the system can learn from monitoring a user pattern and by employing statistical or historical analysis thereof.

The innovation can operate transparently (e.g., working in the background). Other aspects can operate actively with the user, for example, by providing feedback to the user, augmenting searches in front of the user, etc. Over time, a context filter in accordance with the innovation can be tuned to provide highly personalized search capabilities. User feedback can also be used to further train the novel functionality of the aspects of the system.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates context-based computer searches in accordance with an aspect of the innovation.

FIG. 2 illustrates an exemplary flowchart of procedures that facilitate context-based computer searching in accordance with an aspect of the innovation.

FIG. 3 illustrates an exemplary flowchart of procedures that facilitate context-based rendering of search results in accordance with an aspect of the innovation.

FIG. 4 illustrates a system that can determine a user context with respect to computer-based searches in accordance with an aspect of the innovation.

FIG. 5 illustrates an alternative system that employs a data store and a display component to effectuate a computer-based search in accordance with the innovation.

FIG. 6 illustrates an exemplary block diagram of a context determination component having multiple sensors in accordance with an aspect of the novel subject matter.

FIG. 7 illustrates an exemplary block diagram of a context determination component having a number of specific context detection components in accordance with an aspect of the innovation.

FIG. 8 illustrates a block diagram of a results configuration component in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

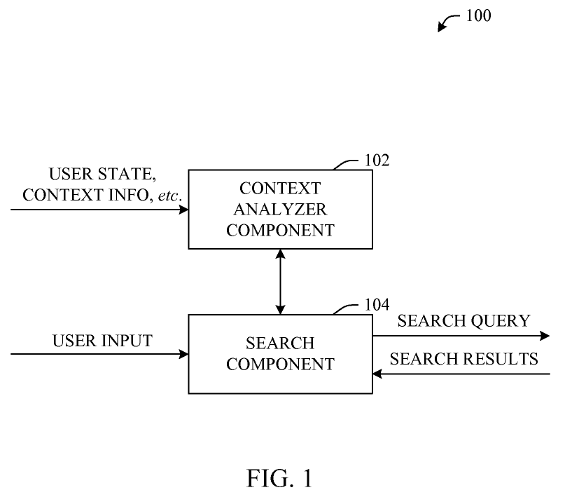

Referring initially to the drawings, FIG. 1 illustrates a system 100 that facilitates computer-based search that considers user state or context in determining search results. For example, if the determined context indicates that a user is driving in a car, in a particular city, at a particular time of day, the searching system can be tailored to return results that are more likely candidates of interest based upon the context. More particularly, suppose this user executes a search query for “restaurants in Seattle,” in one aspect, the novel system 100 can determine where the user is located within Seattle, that it is lunch time, and that the user is in a car. Accordingly, the search results can be tailored to return restaurants within certain proximity of the user that serve lunch and that have a drive-thru. If additionally, a user's current destination is known, the results can be tailored to focus on locations of restaurants that are within some proximity to points on the route.

Essentially, the system 100 can be employed to consider any suitable set of contextual factors in order to modify user input and/or render search query results. Generally, system 100 can include a context analyzer component 102 and a search component 104. As shown in FIG. 1, the context analyzer component 102 can receive context information (e.g., user state). This context information can be analyzed producing a user context that can be fed into the search component 104.

In one aspect, the search component 104 can automatically generate or modify a user-generated search query based upon user context. In another aspect, the search component 104 can employ the user context to rank and/or arrange (e.g., order) search results generated via the user input in accordance with the user context. In yet another aspect, the search component 104 can be employed to filter results generated in accordance with the user input. These results can be filtered based upon information inferred or determined from the user context. In each scenario, it will be appreciated that considering the context in modifying a search input and/or rendering search results can effectively generate meaningful search results to a user. Similarly, this context information can be employed in connection with the novel searching functionality in order to provide target-based advertising and the like.

Although specific examples and scenarios are described herein, it is to be understood and appreciated that other aspects exist that employ the user context in more than one manner. By way of example, in still another aspect, the user context can be employed by the search component 104 to modify the user input as well as to filter, display, or rank search results. It is to be understood that these additional aspects are to be included within the scope of the application and claims appended hereto.

In essence, a feature of the innovation is to incorporate user and/or device context(s) into computer-based searches. Effectively, the novel functionality can provide a more useful mechanism by which a user can obtain information from sources such as the Internet. This information can be tailored, filtered, etc. based upon context of the user and/or the device employed. As will be understood upon a review of the figures that follow, sensors and other mechanisms can be employed in order to gather the information by which the context is determined. The use of these sensors and mechanisms in order to determine the context is yet another novel aspect of the innovation.

It is to be appreciated that the system can modify search queries in accordance with determined and/or inferred context as well as automatically generate queries in the background as a function of user state. For example, a device (e.g., cell phone, computing device, on-board computer system for a vehicle, boat, plane, or machine, etc.) can dynamically generate queries in the background as a function of constantly changing state, initiate searches in the background and cache results for immediate viewing to the user. As an example, searches of databases of detailed highway safety information, conditioned on a current weather context, can be retrieved as a function of the location and velocity of a user's vehicle. Accordingly, the user can be appropriately warned when the expected value of the warning (e.g., to slow down based on prior accident rates at a forthcoming turn in the road) outweighs the cost of the interruption.

As another example, context-sensitive querying can retrieve and cache, for immediate or later rendering, relevant advertisements based on the evolution of the context of a user, and/or the forecasted future contexts of the user.

The search results can be cached and/or immediately displayed or conveyed (e.g., via audio) based on a confidence level that the user would desire or need such information at a particular point in time (e.g., by employing a utility based analysis that factors the cost of interruption to the user with the expected benefit to the user of such information). Results can in effect percolate to the top for conveyance to a user as a function of relevance to user state and needs. Moreover, search results can be aged out/deleted (e.g., to optimize memory space utilization) if no longer relevant given new user state. As discussed herein, advertisers can employ such system to target advertising to users as a function of state/context. Although, the innovations described herein are primarily discussed within the context of user state, it is to be understood that the systems, methods and functionalities described herein can be applied to contexts and states associated with non-humans (e.g., business concerns, processes, machines, animals, other computing systems, etc.).

User profiles and demographics (e.g., user preferences, age, gender, religion, ethnicity, education level, likes, dislikes, interests, occupation, political ideology . . . ) can likewise be employed in connection with the contextual information to facilitate generating rich search queries and obtaining search results that are meaningful to a particular user, filtering and conveying results. Furthermore, the system can aggregate such user information amongst a plurality of users in connection with providing relevant results to a group of individuals (e.g., with similar interaction histories, engaged in a common activity, part of a multi-user collaboration, within a work environment or social network). Such retrieval can benefit from the construction of models of interest from data about information access or consumption patterns by people with similar attributes and/or immersed in similar contexts (e.g., similar demographics, similar locations, etc.).

It should be readily apparent from the discussion herein that the functionality associated with context-based search also can be used as a context-based filter. For example, a two-tiered approach can be employed where queries are modified or reformulated based on the foregoing, and the results as well filtered and re-ranked using such information. Such approach can further facilitate providing meaningful information to a user in a timely manner as well as taking into consideration change of user state during the lag from when a query/search is initiated and results obtained.

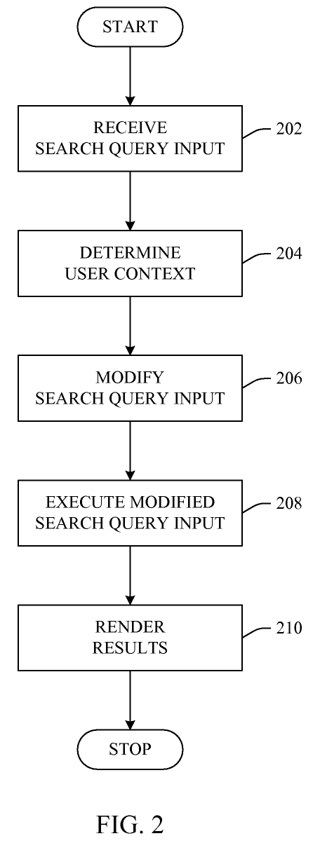

FIG. 2 illustrates a methodology of incorporating context into a search query in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a search query input can be received from a user, application, etc. In one example, this search query can be a keyword or group of keywords or other alpha-numeric string that identifies a desired search criterion. Simultaneously, prior to or subsequent to receipt of the search query, a user context can be determined at 204. As will be understood upon a review of the figures that follow, any mechanism(s) can be employed to obtain, establish and/or generate the information in order to produce the user context.

In accordance with the methodology of FIG. 2, the search query input can be modified in accordance with the user context at 206. For example, a user location can be combined with the search query input in order to limit results based upon a specific location. In other words, the search query input can be modified based upon the context. At 208, this context modified search query can be executed to generate context-based search results.

Finally, the results can be rendered at 210. For example, the results can be rendered via a display and can be organized in any manner desired. In one particular aspect, the results can be rendered in accordance with the user context. By way of more specific example, the results can be ranked, ordered or filtered in accordance with the user context.

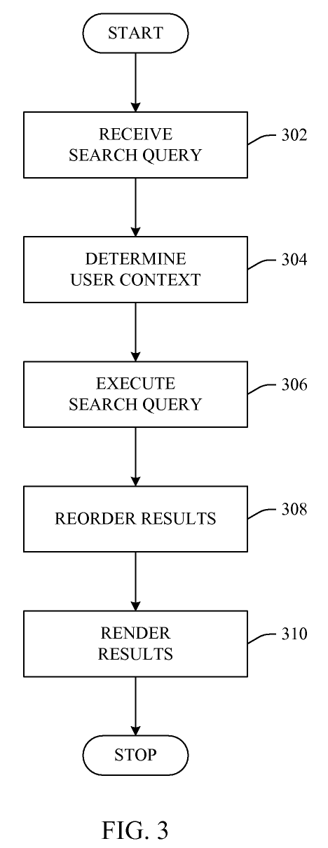

FIG. 3 illustrates a methodology of context-based rendering of search results in accordance with an aspect of the innovation. While this methodology demonstrates a specific example of incorporating the user context into the act of rendering, it is to be understood that other examples of incorporating the user context into the act of rendering can exist. These additional examples and aspects are to be considered within the scope of this disclosure and claims appended hereto. At 302, a search query is received. By way of example, the search query can be any word, string or the like that identifies or describes a desired query. At 304, a user context can be established. In order to establish the user context, information about a user state can be obtained from a variety of sources such as, for example, a global positioning system (GPS), state of concurrently running applications, time of day, personal information manager (PIM) data, visual monitors (e.g., cameras), audio detectors (e.g., microphones), accelerometers, devices/vehicles/machines being employed, device collaboration, service providers, pattern recognition (e.g., detect frowns, smiles . . . ), voice analysis (e.g., detect stress in individual's voice), analysis of background noise (e.g., detect traffic noise in background, sound of the ocean, restaurant environment . . . ), wireless triangulation with cell phone (e.g., in light of GPS shadows), gaze detectors, credit card transactions or the like, location analysis (e.g., just walked into mall), medical-related devices (pace-maker, glucose monitor, hearing aid, prosthetics with built-in circuitry), personal data assistants (PDAs), metadata, tags, etc.

In operation, this information can be processed in order to assist in determining a user context. More particularly, in one aspect, visual information can be employed to determine a user mood or state of mind. In this example, a frown or smile can be employed to determine a user frame of mind. Similarly, recorded sounds (e.g., tone of voice, sighs) can be employed to determine the user mood and/or state of mind.

At 306, the search query can be executed taking into account, or not taking into account the user context. In either case, the results of the search query can be reordered at 308 in accordance with the user context. In other words, the search results can be tailored to conform to the user context. As described in the aforementioned example, the results can be tailored to return restaurants located in a particular part of Seattle that serve lunch and have a drive-thru.

Finally, at 310, the results can be rendered to a user and/or application. It is to be understood that the results can be modified with respect to a particular output rendering device. More specifically, the results can be resized or filtered in accordance with an output device display and/or memory/processing capacity respectively. Similarly, the results can be rendered in accordance with the user context. For instance, if the user is employing a smartphone to conduct the search, the results can be reconfigured to conform to the smaller display as opposed to viewing the results on a standard sized personal or notebook computer. The information itself can be analyzed and less relevant information removed for example to maximize utilization of limited screen real estate and/or device capabilities. Likewise, given the user state, the results can be conveyed in an optimal manner (e.g., conveyed as text, graphics, audio, or combination thereof) so as to provide the user with information in a convenient, glanceable and/or non-obtrusive manner. For example, if the user is a driving a car, search results could be conveyed as audio, but when motion of the vehicle is no longer detected, the information can optionally be conveyed in a visual manner.

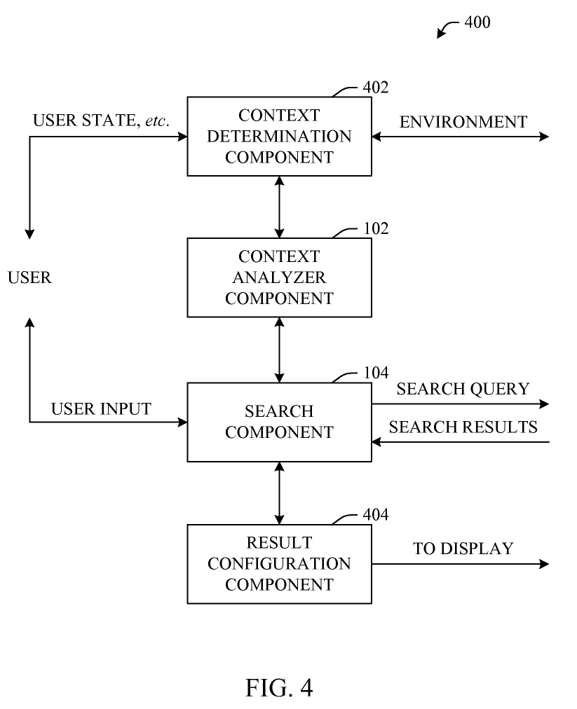

Turning now to FIG. 4, an alternate system 400 that facilitates context-based computer search in accordance with an aspect of the claimed subject matter is shown. Generally, system 400 can include a context determination component 402, context analyzer component 102, a search component 104 and a result configuration component 404. In operation, the system 400 can factor context into a computer-based search. Each of these components will be described in greater detail infra.

The context determination component 402 can be employed to gather data and information necessary to determine a context. Although specific examples of types of data and information related to a context are described herein, it is to be understood that the context determination component 402 can obtain, receive and/or access any type of information that can subsequently be employed to establish the context.

More particularly, context determination component 402 can be employed to generate, receive and/or obtain the context-related information. As shown in FIG. 4, in one aspect, the context determination component 402 can interact with a user to obtain information that can be used to establish a context. In a specific aspect, the context determination component 402 can employ a camera to capture an image of a user. In another aspect, the camera can be employed to capture an image of a location identifying place (e.g., landmark). Still other aspects can employ a microphone to capture audio of a user's spoken word or even just a benchmark of the volume of the background noise in the proximate location of the user.

In any case, the information can be provided to the context analyzer 102 and processed in order to determine particular context. With continued reference to the aforementioned examples, the image of a user can be employed to determine a particular mood or state of mind of a user. For example, an image of a user's face can be used to interpret facial expressions (e.g., smiles, frowns) thus determining a user state/mood. Similarly, an image of the proximate landscape and structures of a user can be processed to identify a location of a user. For example, a photo of the Statue of Liberty can be employed to determine that a user is located in New York City.

Still further, captured audio can be employed to determine context that can be factored into a computer-based search. In a specific example, speech recognition mechanisms can be employed to interpret a user's spoken word. Similarly, audio recognition systems can be employed to determine a context related to user proximity. By way of more specific example, the noise level and type of background noise can be determined and factored into a context-based search. For instance, a user located in an airport might be interested in different search results than users located in an automobile.

As will be understood upon a review of the figures that follow, other sensors and context-determining means can be employed in accordance with disparate aspects of the innovation. For example, location and movement detectors, time and date identifiers, user application state detectors, weather detectors, and the like can be employed to assist in determination of a relevant context that can be factored into a context-based computer search. These examples and scenarios will be described in greater detail with reference to the figures that follow.

Once a context is determined, in one aspect, the context can be employed by the search component 104 in order to modify a user input and generate or reformulate a search query that takes into consideration the established context. As such, the search component 104 can obtain search results taking into account the established context. Subsequently, these results can be rendered to a user or application as desired.

In still another aspect, the result configuration component 404 can be employed to configure the results factoring in the context. For example, the result configuration component 404 can reorder the search results from the most relevant to the least relevant based upon the context. In another example, the result configuration component 404 can filter the results based upon established context. In still another aspect, the result configuration component 404 can rank the results based upon the established context. In one embodiment, this ranking can be employed to arrange the results in an appropriate order. In another embodiment, this ranking can be employed by an application in order to perform some other desired process.

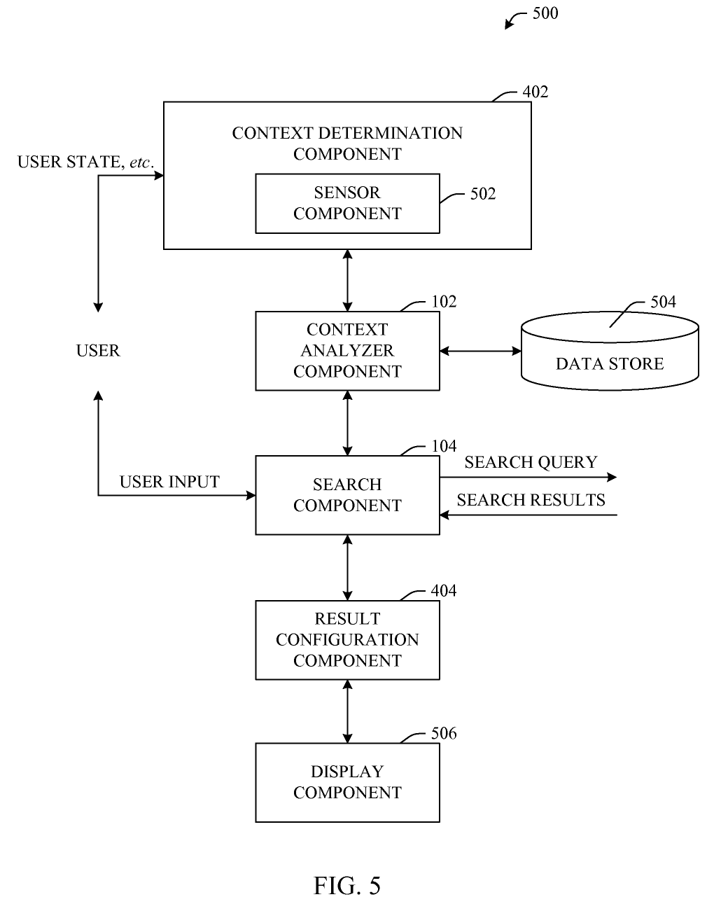

Turning now to FIG. 5, an alternative system 500 that facilitates context dependent computer-based search in accordance with an embodiment of the innovation is shown. More particularly, the system 500 can utilize context to obtain search results and/or to configure search results upon rendering. Although specific scenarios are described herein, it is to be understood that these specific scenarios are exemplary of the novel functionality and are not intended to limit the scope of the innovation in any way. As such, it will be understood that other aspects and uses of the context in order to tailor computer-based searches exist and are to be included within the scope of this disclosure and claims appended hereto.

As shown in FIG. 5, context determination component 402 can include a sensor component 502. As described supra, the sensor component 502 can be employed to capture and/or access information related to the context of the user or application. Once information is gathered, it can be input into the context analyzer component 102 which can evaluate the information and thereafter establish an applicable context. For example, the sensor component 502 can be employed to capture an image of a user whereas the context analyzer component 102 can be employed to interpret characteristics and figures within the overall image.

To assist in analyzing the information, the context analyzer 102 can employ information maintained within a data store 504. For example, the data store 504 can include reference images that can assist in the determination of the context from a captured image. Although a single data store 504 is illustrated in FIG. 5, it is to be understood that multiple data stores (not shown) can be employed in connection with the innovation. As well, it is to be appreciated that any number of reference data sources and stores can be located remotely from the context analyzer component 102 and used in connection with determining the context without departing from the spirit and scope of the innovation. It is to be appreciated, that a rich index (e.g., based in part on historical data relating to user searches as well as click through rates) can be employed to facilitate such context-based analysis and/or to determine or infer context and state given certain extrinsic evidence. It is also to be appreciated that such historical information can be used to train classifiers for personalization as well as base/seed classifiers to be deployed to a plurality of users.

With continued reference to the system 500 of FIG. 5, the context established via the context analyzer component 102 can be input into the search component 104. The search component 104 can incorporate the user state/context into searches. As such, the modified search query can be executed to tailor results in accordance with the context. Once results are search received, the results can be configured (or reconfigured) by the result configuration component 404.

It is to be appreciated that the search component 104 can immediately incorporate context into a search query thereby rendering real-time search results. As well, in alternative aspects, a context (or subset of the factors that establish the context) can be queued and later referred to in order to update and/or obtain search results. By way of example, suppose a user is driving in a car and is interested in locating a sports car dealership in his travels. In this example, the user can enter an input for a particular type of sports car dealership. As the context is updated with respect to the user location, the system 500 can alert the user when a matching sports car dealership that satisfies the input query is within a desired proximity.

It will be understood that this queue and/or alert mechanism can be applied to substantially any search query without departing from the novel concepts of incorporating a user context into a search query. Similarly, a user context can be inferred using artificial intelligence and/or machine learning mechanism. These inference-based models will be described in greater detail infra.

As described above, in operation, the result configuration component 404 can sort, filter, rank, order, etc. the results in accordance with the defined, determined or inferred context. Once organized, in one aspect, the results can be rendered via display component 506. Moreover, it is to be understood the innovation (e.g., result configuration component 404) can configure the results in accordance with the particular display component 506. For example, the results can be configured differently with respect to a desktop computer as compared to the display component 506 of a smartphone in order to maximize interpretation of the results.

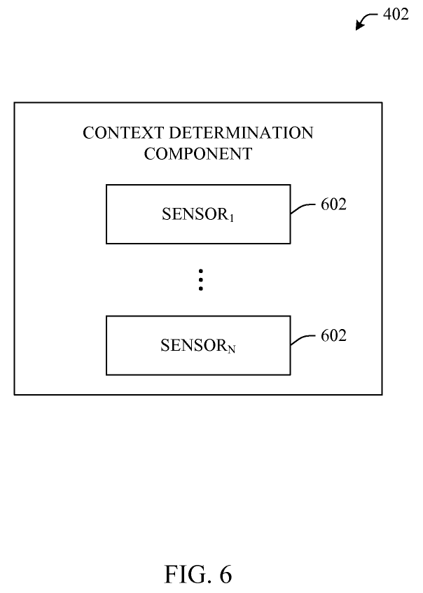

Referring now to FIG. 6, a block diagram of an exemplary context determination component 402 is shown. As illustrated, context determination component 402 can include 1 to N sensor components (or inputs from sensor components) 602, N being an integer. In other words, the context determination component 402 can include any number of inputs from disparate sensory components. It is to be understood that the sensor component(s) 602 can include a sensor or any suitable detecting instrument or software known in the art that can be utilized to determine context-related information.

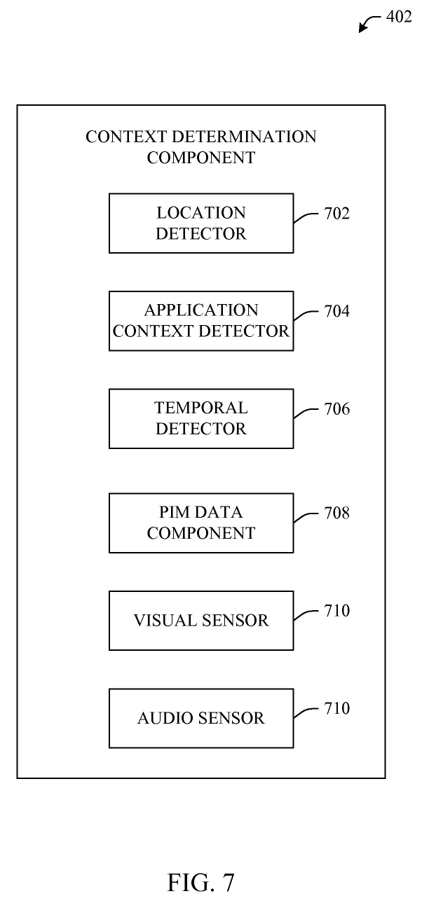

Illustrated in FIG. 7 is a specific example of a context determination component 402. As shown, the context determination component 402 can be employed to establish information about user state from a variety of sources such as, for example, a location detector (e.g., GPS, movement detector, accelerometer), an application context detector (e.g., identification of applications the user is working with), temporal detector (e.g., time of day), PIM data component (e.g., user's calendar), a visual sensor (e.g., camera or visual monitor that can detect a user mood by detecting frowns, smiles or can detect location of a landmark), an audio sensor (e.g., microphone coupled with voice recognition that can identify stress in user's voice, sense of urgency, gender of user, age of user).

In another example, the context determination component can combine sensory mechanisms to determine specifics related to the context of a user such as a specific location and action of a user. More specifically, in one aspect, the context determination component 402 can be employed to determine if a user is located in an office, within a car, walking down a street, etc. All in all, this the contextual and state information gathered via the context determination component 402 can be used to modify search queries, filter and/or re-rank search results so as to facilitate converging on meaningful searches and results. Moreover, metadata about location and other contextual items can be employed to facilitate such searching. Data fusion can also be employed to determine previously unknown correlations among disparate variables to further determine and/or infer context/state.

Machine learning systems (implicitly as well as explicitly trained) can be employed in connection with the innovation so as to provide automated action in connection with the novel computer-based searching mechanisms. In other words, the innovation can employ a machine learning and reasoning component (not shown) which facilitates automating one or more features in accordance with the subject innovation. The subject innovation (e.g., in connection with determining or inferring a context) can employ various Al-based schemes for carrying out various aspects thereof For example, a process for determining a location and/or action of a user can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis to infer an action or state that corresponds to user.

A support vector machine (SVM) is an example of a classifier that can be employed. Other classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria where a user is located, where a user is going, what action a user is performing, what action a user is going to perform, etc.

As described in detail supra, in addition to considering the context to modify a search query thereby tailoring the results to a user input query, the subject innovation can further utilize the context to configure results of a query. It is to be understood that this context-based results configuration novelty can be employed together with, or separate from, the novel context-based query modification described above. In other words, the subject innovation discloses a novel context-based mechanism by which contextual information can be employed to incorporate intelligence into computer-based searching. This intelligence can be incorporated into the actual searching and/or the configuration of search results upon rendering the results.

Statistical machine learning methods can be employed to build models that identify or rank informational items differently based on inferences about context. Databases of cases of events representing informational items, that were identified implicitly or explicitly as being desirable or valuable in specific contexts, can be used to build custom-tailored ranking functions. In some cases, context-sensitive parameters can be passed to ranking functions. In other cases, ranking functions can be more holistically optimized for performance in different contexts. In cases where there is uncertainty in a user's current context, inferences about the probability distributions over the potential contexts at hand can be taken as inputs in retrieval systems that mix together the outputs of multiple ranking systems in a probabilistically coherent manner to provide different kinds of mixtures of results, including an overall ranking and clusters of results, showing the most relevant for each of the potentially active clusters, for example. As a concrete example, the ‘RankBoost’ method, as disclosed in the aforementioned Related Application and incorporated by reference herein, can be optimized for providing ranking for specific contexts.

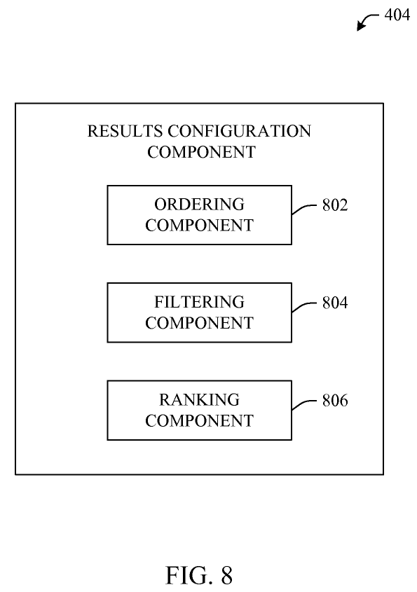

FIG. 8 illustrates an exemplary results configuration component 404 in accordance with an aspect of the innovation. As shown, the results configuration component 404 can include a matching component 802, a filtering component 804 and a ranking component 806. Each of these components can be employed to affect the rendering of the search results in accordance with the determined or inferred context. For instance, a match score can be employed to order as well as rank, select (e.g., top item), cluster, etc.

It is to be appreciated that the innovation can operate transparently (e.g., working in the background) as well as actively with the user (e.g., providing feedback to the user, augmenting searches in front of the user, etc.). Each of these examples is to be considered a part of the novel functionality of the search component (e.g., 104) of the innovation.

Following is yet another exemplary scenario in order to add perspective to the innovation. While this scenario illustrates novel aspects of the innovation, it is to be understood that the scenario is not intended to limit the scope of the innovation in any way. To this end, it is to be understood that the number of scenarios that demonstrate the novel aspects of the innovation are countless. Accordingly, these countless aspects are to be included within the scope of the innovation and claims appended hereto.

Referring now to the exemplary aspect, the novel user/state context determining functionality of the innovation can establish or infer that the user is driving a car, it is Tuesday at 8:55 am, the user's calendar (e.g., PIM data) indicates a scheduled 9:00 am client meeting at United Technologies, and the user is 15 miles from United Technologies' headquarters. Effectively, it can be determined that the user will be late for the 9:00 am meeting. As such, the user may wish to initiate a telephone call to inform the client that he is running late.

A background (or user initiated foreground search) can employ this inferred context to further define the search term “United” as a company the user desires to reach as compared to an airline, a state of collective being, or a freight company. As a result, the correct phone number can be located and the call initiated automatically. Similarly, directions to the company headquarters can be automatically rendered by considering the time of the meeting, current location of the user, etc. In accordance with the novel functionality described herein, over time, a context filter in accordance with the innovation can be tuned to provide highly personalized search and/or rendering capabilities. As well, user feedback can also be used to further train the system.

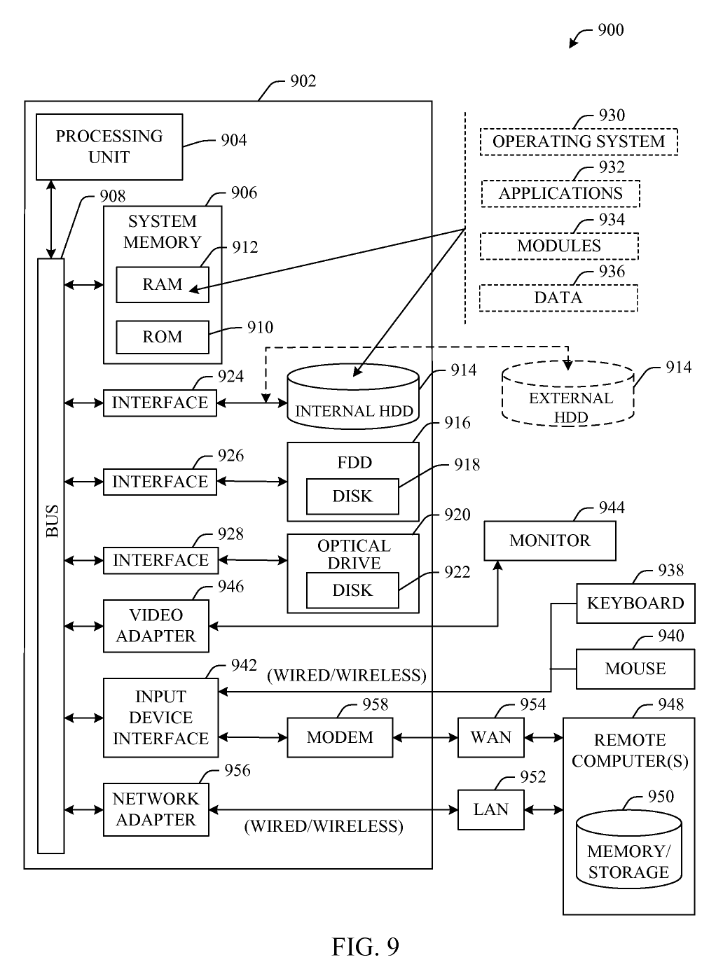

Referring now to FIG. 9, there is illustrated a block diagram of a computer operable to execute the disclosed architecture of context-based computer searching and results rendering. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

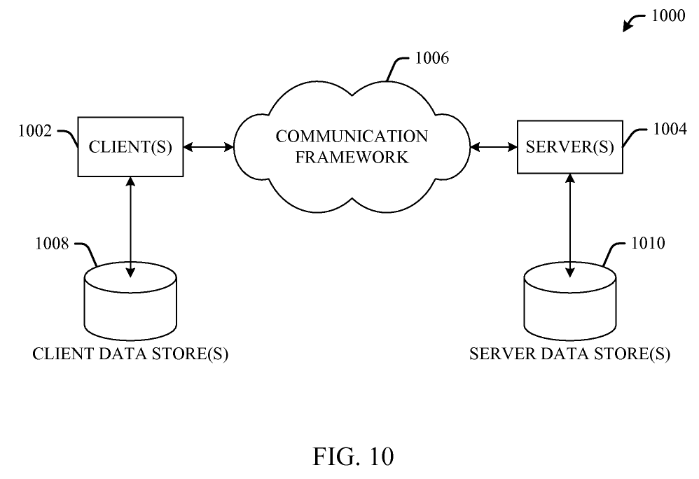

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates computer-based search, comprising:
a context analyzer that determines user context from context-related information; the user context includes at least one of a physical context, an application context, an implicit or explicit user model, and/or a temporal context; and
a search component that generates a search query or analyzes search results based at least in part upon the user context, wherein the search component obtains a plurality of search results based at least in part upon the search query.

2. The system of claim 1, the search component combines a user input with the user context to generate the search query.

3. The system of claim 1, further comprising a context determination component that establishes the context-related information.

4. The system of claim 3, the context determination component employs a plurality of sensors that generate at least a portion of the context-related information.

5. The system of claim 4, the plurality of sensors includes environmental and physiological sensors.

6. The system of claim 4, the plurality of sensors includes at least one of a location detector, a velocity detector, an application context detector, an acceleration detector, a temporal detector, a calendar monitor, a user data and/or interaction component, a camera, and/or a microphone.

7. The system of claim 1, further comprising a results configuration component that manages the plurality of search results based at least in part upon the user context.

8. The system of claim 7, the results configuration component includes a matching component that arranges at least a subset of the plurality of search results based at least in part upon the user context.

9. The system of claim 7, the results configuration component includes a filtering component that selects a subset of the plurality of search results based at least in part upon the user context.

10. The system of claim 7, the results configuration component includes a ranking component that orders a subset of the plurality of search results based at least in part upon a rank; the rank is based upon the user context.

11. The system of claim 1, the context-related information is at least one of a user location, a time of day, a date, an application state and a user state.

12. The system of claim 1, further comprising a result configuration component that arranges a subset of the plurality of search results based at least in part upon the user context.

13. The system of claim 1, the context analyzer employs user-specific information to determine the context.

14. The system of claim 13, the user-specific information is personal information manager (PIM) data.

15. The system of claim 1, further comprising a learning component that learns a context-specific ranking algorithm and renders a subset of the search results as a function of the context-specific ranking algorithm.

16. A computer-implemented method of computer-based searching, comprising:
determining a user context;
modifying a user input query based upon the user context;
executing a search based upon the modified user input query;
obtaining a plurality of search results; and
rendering a subset of the plurality of search results based upon the user context.

17. The method of claim 16, further comprising arranging the subset of the plurality of search results based at least in part upon the user context.

18. The method of claim 16, further comprising selecting the subset of the plurality of search results based at least in part upon the user context.

19. A computer-executable system that facilitates context-based searching, comprising:
computer-implemented means for determining a user context;
computer-implemented means for obtaining a plurality of search results based upon a user input query; and
computer-implemented means for rendering a subset of the plurality of search results based upon the user context.

20. The computer-executable system of claim 19, further comprising computer-implemented means for employing the user context to define the user input query.
